(19) United States
(12) Patent Application Publication
(10) Pub. No.: US 2026/0242899 A1
(43) Pub. Date: Aug. 20, 2026

(54) SPRING LINK

(71) Applicant: BENTELER AUTOMOBILTECHNIK GMBH, Paderborn (DE)

(72) Inventors: Stephan MEYER, Bielefeld (DE); Dirk VOIGT, Altenbeken (DE); Tom HOLMGREN, Gjovik (NO); Branislav KUCKA, Liberec-Jerab (CZ)

(21) Appl. No.: 19/540,787

(22) Filed: Feb. 16, 2026

(30) Foreign Application Priority Data
Feb. 17, 2025 (EP) 25158394.4

(51) Int. Cl. C22C 21/08; A63B 5/11

(52) U.S. Cl. CPC C22C 21/08; A63B 5/11; B60G 2204/148; B60G 2206/428

(57) ABSTRACT

The present disclosure relates to a spring link for a wheel suspension in a motor vehicle. The spring link has a link body made of light alloy. The link body has two side walls and a cover connecting the side walls. According to the present disclosure, at least one buckling force-reduced zone is formed in the link body. The zone has at least one region with material properties that are reduced compared to the original material properties. The zone is at least partially heat-treated, which reduces the buckling force.

### RELATED APPLICATIONS

The present application claims priority of European Application Number 25158394.4 filed Feb. 17, 2025, the disclosure of which is hereby incorporated by reference herein in its entirety.

### BACKGROUND

The present disclosure relates to a spring link for a wheel suspension in a motor vehicle, which has a link body made of light alloy, which has two side walls and a cover connecting the side walls.

As already mentioned in the introduction, spring links have the function of supporting the torques that arise when braking or accelerating and absorbing the forces acting from a shock absorber/damper element. In addition, spring links support the weight of a motor vehicle in cooperation with other chassis components. Therefore, very high demands are placed on the rigidity of a spring link. On the other hand, the spring links are to have the lowest possible component weight. On the side of the unsuspended wheel masses, a low weight has an advantageous effect on the driving dynamics of a motor vehicle.

Spring links or their link bodies are manufactured from light alloy.

A spring link with a link body made of an aluminum alloy is described in DE 10 2020 007 875 A1.

According to EP 4 378 718 A1, a spring link is also described, the link body of which can be formed from an extruded profile made of an aluminum alloy.

Furthermore, in the spring link described in EP 1 232 029 B1, the link body is formed from a closed hollow profile made of high-strength extruded aluminum.

DE 10 2011 112 061 A1 describes a spring link for a wheel suspension in a motor vehicle, which has a link body which has two side walls and a cover connecting the side walls. A constriction that forms a buckling force-reduced zone in which the link body bulges or buckles in a predetermined direction when a compressive force is applied parallel to a longitudinal direction, thereby undergoing plastic deformation is provided in the link body.

A spring is also described in CN 210116342 U.

EP 3 386 841 B1 concerns a rear vehicle body structure. This complex vehicle body structure includes, among other things, a rear support which has at least a front section, an intermediate section and a rear section. The resistance to plastic deformation of the front section is greater than the resistance to plastic deformation of the intermediate section, which in turn is greater than the resistance to plastic deformation of the rear section. To obtain different yield strengths in the sections, these can be subjected to different heat treatments.

The technological background also includes a spring link, as the one explained in EP 4 360 919 A1.

From an insurance perspective, efforts are made to minimize damage to a vehicle in the event of a collision with an obstacle. For safety reasons and also to prevent consequential damage, damage resulting from a collision should also be clearly visible.

In the wheel suspension of a motor vehicle, damage cases resulting from a sudden impact force on the vehicle wheel are of importance. This results in high lateral forces acting on the vehicle wheel, which are transmitted to the chassis of the motor vehicle via the wheel suspension. This results in an increased risk of damage also to chassis or vehicle components downstream in the force transmission chain.

### SUMMARY

The present disclosure is based on the object of creating a spring link with improved load-bearing behavior that meets high stiffness and service life requirements.

The achievement of this object is a spring link.

Embodiments and modifications of features of the spring link according to the present disclosure which, individually or in combination, design and/or refine the present disclosure in a technically advantageous manner can also be found in the description and the accompanying drawings.

Terms such as upper, lower, top, bottom, horizontal, vertical, longitudinal, transverse, or longitudinal and transverse direction as well as upper side and lower side refer to the intended installation position and the orientation of the spring link in the wheel suspension of a motor vehicle.

A spring link according to the present disclosure has a link body that has a U-shaped cross-section. The link body is made of light alloy and is manufactured from an extruded profile. The link body has two side walls connected by a cover.

The two side wall profiles are arranged parallel to one another at a distance along the spring link transverse axis (y-axis). The upper cover extends between the side walls. The lower side of the link body facing away from the upper cover is open. The side walls cantilever freely from the cover.

According to the present disclosure, the link body has at least one buckling force-reduced zone. In the buckling force-reduced zone, the buckling force of the link body is reduced. In the region of the buckling force-reduced zone, the spring link has a targeted set structural weakness compared to adjacent regions. If a predetermined load is exceeded, such as under axial pressure on the link body, the stability of the link body in the buckling force-reduced zone is exceeded and lateral deflection occurs. In the buckling force-reduced zone, the bending stiffness of the cross-section of the link body and/or the modulus of elasticity (E-modulus) of the link body material is set so that the component fails and buckles in a targeted manner. The buckling force-reduced zone defines the location in the link body where bulging or buckling of the link body begins. Furthermore, the buckling force-reduced zone is designed in such a way that the direction in which the spring link or the link body buckles is determined by the force deflection.

The present disclosure creates a lightweight spring link made of light alloy, which is inexpensive to produce. The spring link exhibits high durability and meets sufficiently high service life expectations. The spring link meets high stiffness requirements and has high fatigue strength. The spring link fulfills the intended static and dynamic requirements and simultaneously ensures controlled buckling behavior in the event of an overload.

The buckling force-reduced zone is designed and arranged in such a way that the link body or components of the link body bulges or buckles in a predetermined direction when a compressive force is applied in parallel to its longitudinal direction, thereby undergoing plastic deformation. In a collision, the spring link absorbs forces and converts them into deformation work.

Furthermore, the buckling force-reduced zone is designed so that the spring link deforms in a predetermined direction. Such a predetermined direction of deformation is designed to lead away from other components of the wheel suspension in order to avoid damaging them as much as possible.

The link body is made from an extruded profile of a light alloy material. The link body of the spring link can also be forged or cast. The link body of the spring link can therefore be an extruded profile, a forged profile or a cast profile. In at least one embodiment of the present disclosure, the link body is made of aluminum or an aluminum alloy, of the 6000 series, aluminum alloy 6082 (EN AW-6082).

According to the present disclosure, the buckling force-reduced zone has at least one region that has material properties that are reduced compared to the original material properties of the region.

According to the present disclosure, the zone is at least partially heat-treated. The heat treatment reduces the buckling force in the zone and adjusts the buckling force to the desired deformation properties of the link body.

The heat treatment of the link body is carried out in the regions where the buckling force is to be reduced.

In at least one embodiment of the present disclosure, the heat treatment is carried out inductively using an inductor.

The temperature of the heat treatment ranges between 250° C. and 500° C. The duration of the heat treatment is short. In at least one embodiment of the present disclosure, the heat treatment takes place in a time of less than 15 seconds.

According to the present disclosure, the yield strength Rp0.2 is reduced in the buckling force-reduced zone. In at least one embodiment of the present disclosure, the yield strength Rp0.2 in the zone is reduced by a factor of between 0.3 and 0.6 compared to the yield strength Rp0.2 of the starting material.

A buckling force-reduced zone can be provided in a side wall and/or the cover. The arrangement of one buckling force-reduced zone and/or, for example, several buckling force-reduced zones in the link body relative to each other is designed in such a way that buckling in or around the y-axis and buckling around the z-axis is decoupled. A buckling force-reduced zone in a side wall and a buckling force-reduced zone in the cover can be arranged offset from each other along the longitudinal axis of the spring link.

In at least one embodiment of the present disclosure, a buckling force-reduced zone is arranged between the spring seat or a spring seat support of the spring link and an axle carrier-side bearing section of the spring link.

In at least one embodiment of the present disclosure, the buckling force-reduced zone has a width measured in the longitudinal axis of the spring link (x-axis) which is dimensioned between 5 mm and 50 mm.

The buckling force-reduced zone can have a main region and at least one transition region. The yield strength Rp0.2 is lower in the main region than in a transition region.

In at least one embodiment of the present disclosure, a transition region adjoins each main region on both sides.

The main region can, for example, have a width of 20 mm. The transition region is approximately 5 mm wide. With a main region having a width of 20 mm, which is bordered on both sides by a transition region with a width of approximately 5 mm, the resulting width of the buckling force-reduced zone is 30 mm.

In at least one embodiment of the present disclosure is a buckling force-reduced zone extending in a strip shape over the entire height of one side wall of the link body.

Furthermore, a buckling force-reduced zone can extend across the cover between the two side walls. The buckling force-reduced zone in the cover also extends across the cover in a strip.

The main region of a buckling force-reduced zone has a width. Similarly, a transition region has a width. The width of the main region is greater than the width of a transition region.

In at least one embodiment of the present disclosure, it is provided that the link body has a notch and/or a groove and/or a recess. The notch and/or the groove and/or the recess are arranged in the region of the buckling force-reduced zone. The notch, groove, or recess results in a mechanical weakening of the component strength. This allows the buckling behavior to be adjusted and determined.

The mechanical weakening of the link body by a notch, a groove or a recess forms a predetermined deformation point. This initiates or supports the buckling behavior of the link body. Furthermore, this mechanical predetermined deformation point can be used to specify a buckling or bulging direction.

Furthermore, if the notch and/or the groove and/or recess is arranged in the transition or adjacent to the transition of a side wall to the cover is advantageous.

In a design advantageous for practical purposes, each side wall has an outwardly directed upper rib extending in the longitudinal direction of the link body.

The rib may have an upward-facing arched section. In at least one embodiment of the present disclosure, an arched section is provided in the region of the spring seat. It is advantageous to arrange an upwardly directed arched section in each rib of a side wall. An arched section is arranged in the transition from the spring seat support to the axle carrier-side longitudinal section of the link body.

Furthermore, each side wall can have a lower free end section, wherein the end section is curved inwards. Curved inwards means that the end sections point in the direction of the spring link longitudinal axis (x-axis). The inward-facing end section is advantageous due to space constraints. The end section can also run straight or be directed outwards. It is also possible that the side wall has a thickening in the region of the end section to increase stiffness.

### BRIEF DESCRIPTION OF THE DRAWINGS

The present disclosure is described in more detail hereinafter by means of an exemplary embodiment illustrated in the drawings. In the figures:

FIG. 1 shows a spring link according to at least one embodiment in a perspective view;

FIG. 2 shows the spring link as shown in FIG. 1 in a side view according to at least one embodiment;

FIG. 3 shows the spring link in a front view according to at least one embodiment; and

FIG. 4 shows the spring link in a top view according to at least one embodiment.

### DETAILED DESCRIPTION

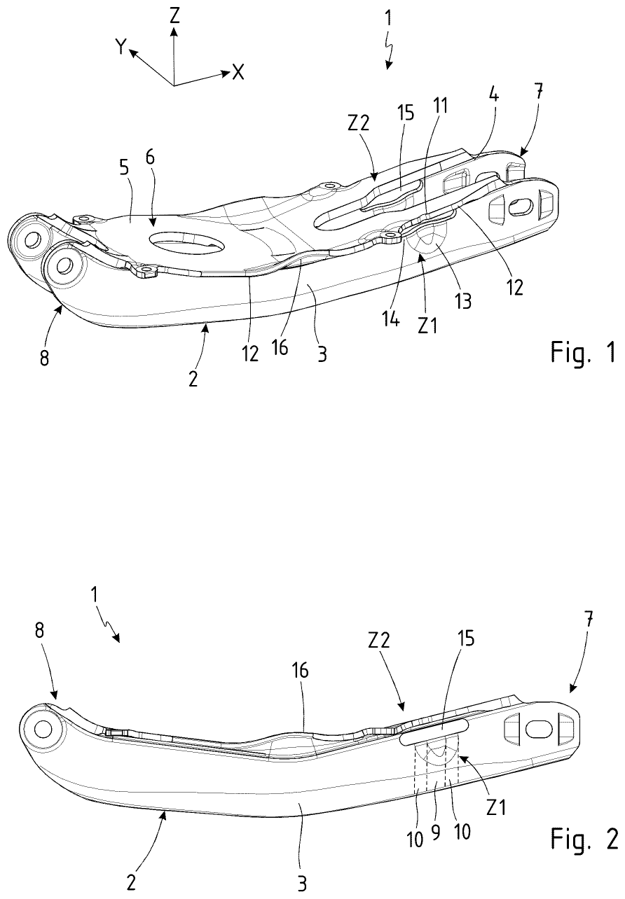

A spring link 1 according to the present disclosure is described with reference to FIGS. 1 to 4.

A coordinate system is shown in FIG. 1 in order to define the position of the individual components in the construction of the spring link 1. The x-axis corresponds to the spring link longitudinal axis, the y-axis corresponds to the spring link transverse axis, and the z-axis corresponds to the spring link vertical axis.

The spring link 1 has a link body 2. The link body 2 is made of light alloy and has two side walls 3, 4 and a cover 5 connecting the side walls 3, 4.

The link body 2 is an extruded profile, a forged profile or a cast profile made of aluminum or an aluminum alloy. The link body 2 is made of aluminum or an aluminum alloy of the 6000-series. For practical purposes, the aluminum alloy 6082 is considered advantageous, wherein it is an aluminum-magnesium-silicon wrought alloy.

A side wall 3, 4 has a thickness that is advantageous in practice between 4.0 mm and 6.5 mm. The cover 5 of the link body 2 is between 4.0 mm and 10.0 mm thick.

The side walls 3, 4 can have a varying thickness profile both in the longitudinal direction (x-axis) of the link body 2 and in the vertical axis of the spring link (z-axis). In the region of the spring seat, the side walls 3, 4 can have a greater thickness than in a middle longitudinal section or in the region of upper rib sections of a side wall 3, 4.

The side walls 3, 4 of the link body 2 are mirror-symmetrical to each other and arranged parallel to each other at a distance. A spring seat support 6 is formed in the cover 5. The link body 2 has a bearing section 7 on the wheel carrier side and a bearing section 8 on the vehicle body side.

The link body 2 is designed with buckling force-reduced zones Z1 and Z2. A first buckling force-reduced zone Z1 extends over the height of a side wall 3, 4.

A second buckling force-reduced zone Z2 runs across the width of the cover 5.

Zones Z1 and Z2 are shown in a technically schematic, dashed-dotted manner in FIGS. 2 and 4.

Both zone Z1 and zone Z2 are located between the spring seat support 6 and the axle carrier-side bearing section 7.

In the buckling force-reduced zone Z1, Z2, the buckling force of the link body 2 or the side walls 3, 4 and cover 5 is reduced. The reduction of buckling forces in zone Z1, Z2 is achieved by a local or partial heat treatment of the link body 2 in zone Z1, Z2. During heat treatment, the link body 2 is heated inductively in zones Z1, Z2 by means of an inductor to a temperature between 250° C. and 500° C. The duration of the heat treatment is less than 15 seconds.

According to at least one embodiment of the present disclosure, the yield strength Rp0.2 in the zone Z1, Z2 is reduced by a factor of between 0.3 and 0.6 compared to the yield strength Rp0.2 of the starting material.

Due to the local heat treatment of the link body 2 in the region of a buckling force-reduced zone Z1, Z2, the spring link 1 has a targeted structural weakness compared to the adjacent component sections of the link body 2. In an overload case, when a predetermined compressive load in the longitudinal direction of the spring link 1 is exceeded, the link body 2 buckles in the region of a buckling force-reduced zone Z1, Z2. The buckling begins in zone Z1, Z2. The design and configuration of a buckling force-reduced zone Z1, Z2 is such that, in addition to targeted deformation, the direction of deformation is also controlled in which the link body 2 is to deform. This can reduce damage to downstream chassis or vehicle components.

In zone Z1, Z2, the material properties of the link body 2 are optimized for the buckling behavior of the link body 2 by a partial heat treatment. The strength is reduced in a buckling-reduced zone Z1, Z2, and the ductility is increased. In the region of the buckling force-reduced zone Z1, Z2, the material of the link body 2 can deform strongly plastically. This improves the overall crash performance and energy absorption capacity of the spring link 1.

Zones Z1 and Z2 have a main region 9 and a transition region 10 adjacent to each main region 9. The yield strength Rp0.2 is lower in the main region 9 than in the transition region 10. In these regions, a zone Z1, Z2 has material properties that are reduced compared to the original material properties of region 9, 10.

The main region 9 has a width BH. A transition region 10 has a width BÜ. The width BH of the main region 9 is greater than the width Bü of a transition region 10. In a practical exemplary embodiment, the main region 9 has a width of approximately 20 mm. The transition region 10 is approximately 5 mm wide.

Outside the buckling force-reduced zones Z1, Z2, the link body 2 has a yield strength Rp0,2 of greater than 280 MPa and a tensile strength Rm of greater than 300 MPa. These are the original material properties. In a buckling force-reduced zone Z1, Z2, the yield strength Rp0,2 in the main region 9 is 140 MPa to 180 MPa, 150 MPa. In a transition region 10, the yield strength Rp0.2 is greater than in a main region 9. The yield strength Rp0.2 in a transition region 10 can, for example, be 200 MPa.

According to at least one embodiment, a buckling force-reduced zone Z1, Z2 can have a width B measured in the longitudinal axis (x-axis) of the link body 2 of 10 mm to 50 mm. This refers to the total width, which is composed of the width of the main region 9 and the width of the transition regions 10.

Furthermore, the link body 2 has a notch 11 in the region of zone Z1, Z2. A notch 11 is provided in each side wall 3, 4 in an outwardly directed upper rib 12.

Furthermore, a groove 13 is arranged in each side wall 3, 4. The groove 13 is formed in the transition 14 from the upper rib 12 to a side wall 3, 4. The groove 13 extends in a triangular shape downwards from the rib 12 to approximately the middle of a side wall 3, 4. The groove 13 is located within the zone Z1 of a side wall 3, 4.

Although the illustrated embodiment shows a triangularly configured groove 13, a groove can also be configured geometrically differently.

Adjacent to the transition 14 of each side wall 3, 4 to the cover 5, a recess 15 in the form of a slot is also arranged. The recess 15 extends over the width of a buckling-reduced zone Z1 at the upper end of a side wall 3, 4 below an outwardly directed rib 12. The slot-shaped recess 15 is longer than it is high. The recess 15 can have a height between 4 mm and 10 mm.

The groove 13 is arranged in a side wall 3, 4 below the recess 15.

In the illustrated embodiment, the recess 15 is shown in the buckling force-reduced zone Z1 of a side wall 3, 4. According to at least one embodiment, a recess 15 can also be provided next to or offset from a buckling force-reduced zone Z1.

The notch 11, the groove 13 and the recess 15 form a mechanical predetermined deformation point in the link body 2, which can initiate, support and guide the buckling behavior or buckling. This advantageously supports the reduction in buckling force induced by local heat treatment.

In the upper ribs 12 of a side wall 3, 4 a locally limited upwardly directed arched section 16 is provided. The arc section 16 is arranged in the region of the spring seat or in front of the spring seat support 6 in the direction of the axle carrier-side bearing section 7. The upwardly curved arched sections 16 increase the stiffness of the link body 2 and improve fatigue oscillating strength.

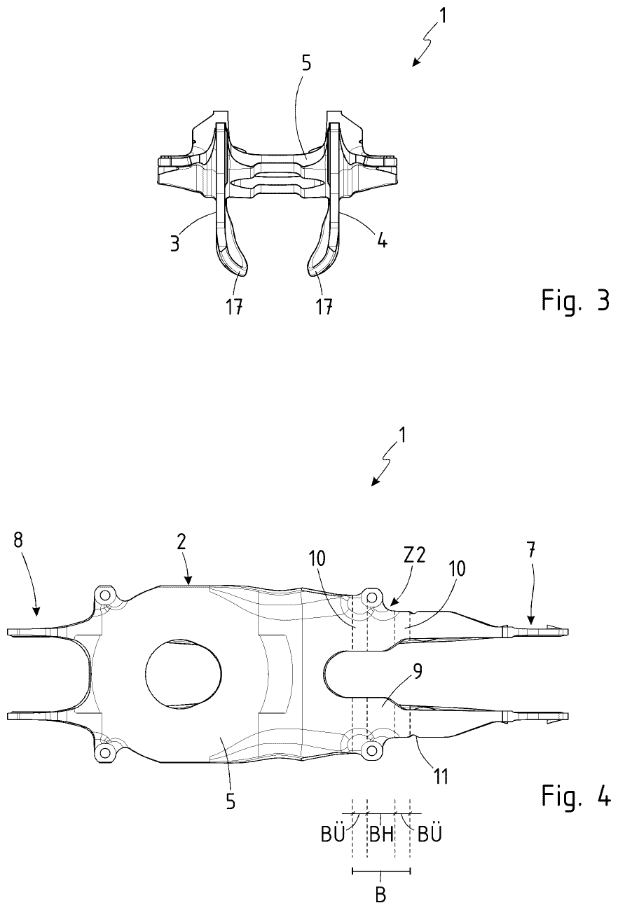

Furthermore, each side wall 3, 4 has a lower free end section 17, wherein the end sections 17 are curved inwards (see FIG. 3). This measure also contributes to increasing the stiffness of the link body 2 and improving its fatigue swinging strength.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-12. (canceled)

13. A spring link for a wheel suspension in a motor vehicle, the spring link comprising:
a link body, the link body having two side walls and a cover connecting the two side walls, wherein
the link body has a buckling force-reduced zone, the buckling force-reduced zone having at least one region which has material properties that are reduced compared to original material properties of an original material of the at least one region, and
the buckling force-reduced zone is at least partially heat-treated by a heat treatment, and a buckling force in the buckling force-reduced zone is reduced by the heat treatment.

14. The spring link according to claim 13, wherein a yield strength Rp0,2 in the buckling force-reduced zone is reduced by a factor of between 0.3 and 0.6 compared to a yield strength Rp0,2 of the original material.

15. The spring link according to claim 13, wherein the buckling force-reduced zone is in a side wall of the two side walls, or in the cover.

16. The spring link according to claim 13, wherein the buckling force-reduced zone has a width, which is measured in a longitudinal axis of the link body, between 5 mm and 50 mm.

17. The spring link according to claim 13, wherein the buckling force-reduced zone has a main region and a transition region, and a yield strength Rp0,2 in the main region is lower than a yield strength Rp0,2 in the transition region.

18. The spring link according to claim 17, wherein, along a longitudinal axis of the link body, a width of the main region is greater than a width of the transition region.

19. The spring link according to claim 13, wherein the link body, in the buckling force-reduced zone, has a notch.

20. The spring link according to claim 19, wherein the notch is arranged in, or adjacent to, a transition of a side wall of the two side walls to the cover.

21. The spring link according to claim 13, wherein each of the two side walls has an outwardly directed upper rib extending in a longitudinal direction of the link body.

22. The spring link according to claim 21, wherein the rib has an upwardly directed arched section.

23. The spring link according to claim 13, wherein
each of the two side walls has a lower free end section, and
the lower free end section is curved inwards or the lower free end section is curved outwards or the lower free end section has a thickening at a free end thereof.

24. The spring link according to claim 13, wherein the link body comprises an extruded profile of aluminum or an aluminum alloy.

25. The spring link according to claim 13, wherein the link body, in the buckling force-reduced zone, has a groove.

26. The spring link according to claim 25, wherein the groove is arranged in, or adjacent to, a transition of a side wall of the two side walls to the cover.

27. The spring link according to claim 13, wherein the link body, in the buckling force-reduced zone, has a recess.

28. The spring link according to claim 27, wherein the recess is arranged in, or adjacent to, a transition of a side wall of the two side walls to the cover.

29. The spring link according to claim 13, wherein the link body is of aluminum or an aluminum alloy.

30. The spring link according to claim 13, wherein the link body comprises a forged profile of aluminum or an aluminum alloy.

31. The spring link according to claim 13, wherein the link body comprises a cast profile of aluminum or an aluminum alloy.
